(19) United States
(12) Patent Application Publication
(10) Pub. No.: US 2002/0078797 A1
(43) Pub. Date: Jun. 27, 2002

(54) Crown tightening tool

(75) Inventor: Kimiko Oyabu, Ichinomiya-shi (JP)

Correspondence Address: ARMSTRONG,WESTERMAN & HATTORI, LLP, 1725 K STREET, NW., SUITE 1000, WASHINGTON, DC, 20006, US

(73) Assignee: Corporation YUUBIDO, Ichinomiya-shi (JP)

(21) Appl. No.: 10/020,949

(22) Filed: Dec. 19, 2001

(30) Foreign Application Priority Data
Dec. 26, 2000 (JP) 2000-395801
Aug. 31, 2001 (JP) 2001-264047

(51) Int. Cl. G04D 3/00

(52) U.S. Cl. 81/6

(57) ABSTRACT

The crown tightening tool can be carried as an accessory by a user of a wristwatch and the user can always perform the tightening of the crown.

A crown tightening tool 10A is constituted by an engaging part 18A which can be engaged with a crown 5 projected from a watch body 3 of a wristwatch 1, and a handle part 11A which is engaged with the engaging part 18A and rotates the engaging part 18A. On one end of the engaging part 18A, a fitting recess 182 is formed and can be engaged with a groove formed on outer circumferential surface of the crown 5, and on other and, a fitting recess is formed and can be engaged with the handle part 11A. The handle part 11A is formed in long pin shape, and a slender plane part 112 is formed on the center part partially, and a knurling treatment part 111 for skid prevention is formed on nearly whole circumference. Further on one end of the handle part 11A, a small hole 113 is formed and a neck string 19 can be inserted in the small hole 119 thereby the crown tightening tool 10A is used as an accessory.

### BACKGROUND OF THE INVENTION

(1) Field of the Invention

The present invention relates to a crown tightening tool of a wristwatch, and more specifically to a crown tightening tool where an owner of a water-proof watch can tighten a crown of the water-proof watch.

(2) Description of the Prior Art

In wristwatches, that of automatic winding type, that of manual winding type, and that of water-proof type are known. In these watches, a crown to move hands is coupled by screws so as to move the hands of the watch and is arranged to the body of the watch. After the adjustment of the hands, adjustment of date and the like are performed in the manufacturing process, the watch is provided as a finished product to customers.

A crown is arranged projecting from the body so that while the user uses the watch, the user can operate the crown for the adjustment of hour or date or the operation of other function. Then the user has performed the tightening of the crown, winding of the crown in automatic winding type, or tightening of the crown in manual winding type.

On the other hand, in a water-proof watch, the watch is assembled with a packing or the like enclosed therein so that water does not enter the watch, and the watch is constituted in sealed structure so that while the watch is installed to a human body, for example, the user can enter a bath or can dive in a sea. However, since a crown is constituted to rotate by operation of the user, even in a water-proof watch, if tightening of the crown is loose, water may enter from a surrounding area of the crown. Therefore the crown must be tightened firmly.

Particularly even in the state that water enters the water-proof watch due to insufficient tightening of the crown therefore the watch must be repaired, the cost for the repair must be borne by the user himself. Consequently the tightening work of the crown must be performed carefully well.

Therefore in some case, operation by hands is not performed but a general tool is used. In the general tool, however, the crown itself and its neighboring portion are liable to be damaged, and the value of the watch may be deteriorated.

In the prior art, as shown in FIG. 18, a pair of pliers 50 to tighten a crown in manufacturing process is known (refer to JU-A 55-175895). However, the pair of pliers 50 is mainly used to assemble the crown to the winding shaft when the watch is assembled. In this case, such a crown tightening tool does not particularly exist that a crown assembled to and projected from the watch body is tightened.

Further in some watch, in order to protect a crown, a wall part as a crown guard is formed in one direction. In this case, in the pliers 50 in the prior art as shown in FIG. 18, a grasping part for grasping at the top end can not be inserted within the wall part as the crown guard therefore the crown can not be grasped. Consequently in the assembled watch, the pliers 50 can not be used in the case that the projection amount of crown from the body of the watch is small or in a wristwatch where a crown guard is formed.

### SUMMARY OF THE INVENTION

An object of the present invention is to solve the above-mentioned problems, and to provide a crown tightening tool which can tighten a crown sufficiently in order to strengthen waterproofing effect of a water-proof watch, and does not damage the crown and is readily used and can tighten the crown corresponding to many sorts of watches, and further has ornamental property and design property.

In order to solve the above-mentioned problems, a crown tightening tool according to the present invention is constituted as follows.

A crown tightening tool to tighten a crown of a wristwatch,

where the crown tightening tool is provided with an engaging part capable of being engaged with the crown in the projected state from a watch body, and with an operation handle part to be arranged to be capable of being put on and taken off the engaging part, and is formed linearly, and

the engaging part is provided with a fitting recess to be engaged with all or a part of a groove part formed on an outer circumferential surface of the crown, and with a handle engaging part capable of being engaged with the operation handle part,

characterized in that the operation handle part is rotated along the axial center, thereby the crown can be rotated.

A crown tightening tool of the present invention, in above-mentioned constitution, is engaged with a crown projected from a watch body thereby a crown can be tightened securely although it can not be sufficiently tightened in operation by hands. Thus in the case of a water-proof watch, since the crown can be tightened to a prescribed position, the water proving effect can be strengthened. Also since other end of the engaging part is formed to be capable of being put on and taken off the operation handle, the operation handle is rotated in one direction thereby the crown can be rotated through the engaging part along the axial center thus the tightening work can be performed quite easily even by a weak strength.

Also the crown tightening tool is that to tighten the crown of the wristwatch, and is provided with an engaging part capable of being engaged with the crown in the projected state from the watch body, and with an operation handle part arranged to be capable of being put on and taken off the engaging part, and is formed linearly, and the engaging part has a recess molded on the outer circumferential surface of the crown,

characterized in that a thermoplastic resin is filled in the recess and is fitted to the crown at high temperature state thereby a female die of the crown is formed in the recess.

Consequently when the thermoplastic resin filled in the engaging part of the crown tightening tool is made the high temperature state and is pushed to the crown, the female die of the crown can be molded in the thermoplastic resin. Thus in any crown, a crown tightening tool corresponding to various sorts of watches can be provided respectively.

Also when an operation handle part is formed in long pin shape and a small hole is formed in one end part, for example, a neck string is inserted in the small hole thereby the crown tightening tool having the engaging part engaged with the operation handle part can be installed as an accessory to a human body.

Further the crown tightening tool is that to tighten a crown of a watch, and has an engaging part capable of being engaged with the crown in the projected state from the watch body and is constituted to be capable of being put on and taken off the crown, and

the engaging part has a pair of plates arranged in parallel with respect to the crown, and the pair of plates are installed slidable mutually,

characterized in that the pair of plates hold the crown and then are moved in reverse directions respectively thereby the crown can be rotated.

Therefore the crown is engaged with the two opposite surfaces and is slided thereby the crown can be tightened, and the crown tightening tool can be suitably used for a wristwatch with crown guard formed and can be used corresponding to various sorts of watches being different in the crown shape. Moreover the engaging part formed in shape of a pair of plates is attached to a human body thereby the crown tightening tool can be used as an accessory in addition to function of the tool.

Also locking grooves are formed on the surfaces opposite to the crown in the pair of plates, and can be engaged with the groove part formed on the outer circumferential surface of the crown. Consequently when the pair of plates are slided, the locking grooves can be engaged with the groove part of the crown thus the crown can be tightened sufficiently. Therefore in the case of a water-proof watch, the waterproofing effect can be strengthened.

Further since the pair of plates are formed having elastic material with the energizing force acting in the direction mutually coming close, when the crown tightening tool is engaged with the crown, the crown can be always held, thereby the tightening operation of the crown can be performed easily.

Also the crown tightening tool is that to tighten a crown of a watch, and has engaging part capable of being engaged with the crown in the projected state from the watch body and is constituted to be arranged to be capable of being put on and taken off the crown, and

the engaging part is provided with a pair of plates arranged in parallel with respect to the crown, and the pair of plates are formed in endless state with both ends connected,

characterized in that the pair of plates hold the crown and then are moved in one direction thereby the crown can be rotated.

Consequently the engaging part is engaged with the crown and then is moved to rotate in one direction thereby the tightening operation of the crown can be performed easily. Also since the crown can be tightened so as to hold the two opposite surfaces, the crown tightening tool can be suitably used to a wristwatch with a crown guard formed. Moreover when the crown tightening tool formed in the endless state is installed as a bracelet to an arm, it can be used as an accessory.

Also in the pair of plates, since a locking groove is formed and can be engaged with a groove part formed on the outer circumferential surface of the crown, when the locking groove is engaged with the crown and moved to rotate in one direction thereby, the crown can be tightened sufficiently, and in the case of a water-proof watch, the water proving effect can be strengthened.

### BRIEF DESCRIPTION OF THE DRAWINGS

FIG. 1 is a front view showing state that a crown tightening tool is installed to a wristwatch crown;

FIG. 2 is an exploded assembling diagram showing a first embodiment;

FIG. 3 is a sectional view showing a crown engaging part in FIG. 2;

FIG. 4 is a perspective view showing another crown tightening tool in the first embodiment;

FIG. 5 is a plan view showing a handle part of the crown tightening tool in FIG. 4;

FIG. 6 is a view in X arrow in FIG. 5;

FIG. 7 is a front view showing an engaging part in FIG. 4;

FIG. 8 is a view in Y arrow in FIG. 7;

FIG. 9 is a view in Z arrow in FIG. 5;

FIG. 10 is a front view showing state that the crown tightening tool in FIG. 4 is used as an accessory;

FIG. 11 is a perspective view showing a crown tightening tool in a second embodiment;

FIG. 12 is an assembling diagram of the crown tightening tool in FIG. 11;

FIG. 13 is a function diagram showing state that the crown tightening tool in FIG. 12 is slided;

FIG. 14 is a perspective view showing a tightening function of a crown in a wristwatch where a crown guard is formed by the crown tightening tool in the second embodiment;

FIG. 15 is a perspective view showing a crown tightening tool in a third embodiment;

FIG. 16 is a front view showing the crown tightening tool of the third embodiment in FIG. 15;

FIG. 17 is a front view showing function of the crown tightening tool of the third embodiment in FIG. 16; and

FIG. 18 is a schematic diagram showing a crown tightening tool (pliers) in the prior art.

### DESCRIPTION OF THE PREFERRED EMBODIMENTS

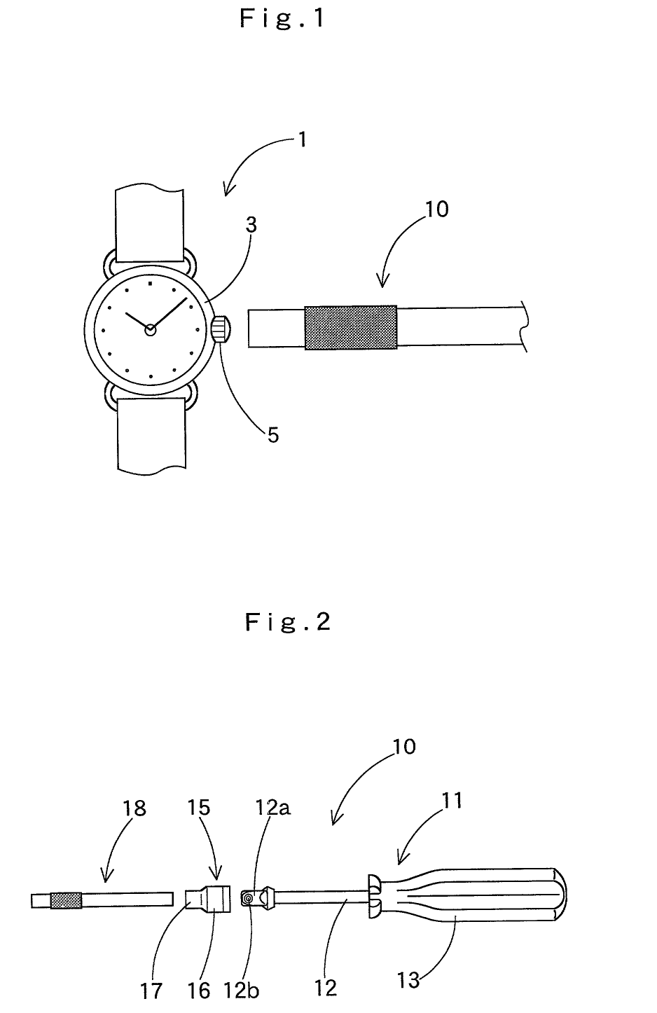

An embodiment of the present invention will be described referring to the accompanying drawings as follows. A crown tightening tool described as follows as shown in FIG. 1 is provided with an engaging part capable of being engaged with a crown 5 projected from a body 3 of a wristwatch 1 and is installed to the crown 5. The crown 5 is rotated in one direction thereby the crown 5 is screwed and tightened into the body 3.

A crown tightening tool 10 in the first embodiment, as shown in FIG. 2, is provided with an operation handle body (operation handle part) 11, a connection attachment 15 and a crown engaging part 18, and shows socket wrench type.

The operation handle body 11 has a stem 12 made of iron or stainless steel, and a handle part 13 made of a resin material with a groove part being fixed at one end side of the stem 12 and readily operated. At the top end part of the stem 12, a mounting part 12a is formed to install an attachment 15. The mounting part 12a is formed in square column shape and one surface or two surfaces of the mounting part 12a, a lock member 12b of spheric shape is pushed by a spring (not shown) and is arranged to be put on and taken off the surface of the mounting part 12a. In the operation handle body 11, an operation handle body of a socket wrench in general use may be used.

The attachment 15 is provided at one end with a socket part 16 externally fitted to the mounting part 12a of the stem 12, and at other end with a recess 17 externally fitted to one end of a crown engaging part 18 in the state which is capable of being put on and taken off. As long as the recess 17 has shape to be fitted to shape of the crown engaging part 18 at one end side and the crown engaging part 18 can be arranged in the state which is capable of being put on and taken off, the shape of the recess 17 is not particularly limited. Also the attachment 15 is provided with various sorts of size depending on size of the crown engaging part 18. Consequently size of any of various sorts of the attachment 15 is formed in the same size regarding the socket part 16, and size of the recess 17 is formed in various sorts of size depending on size of the crown engaging part 18.

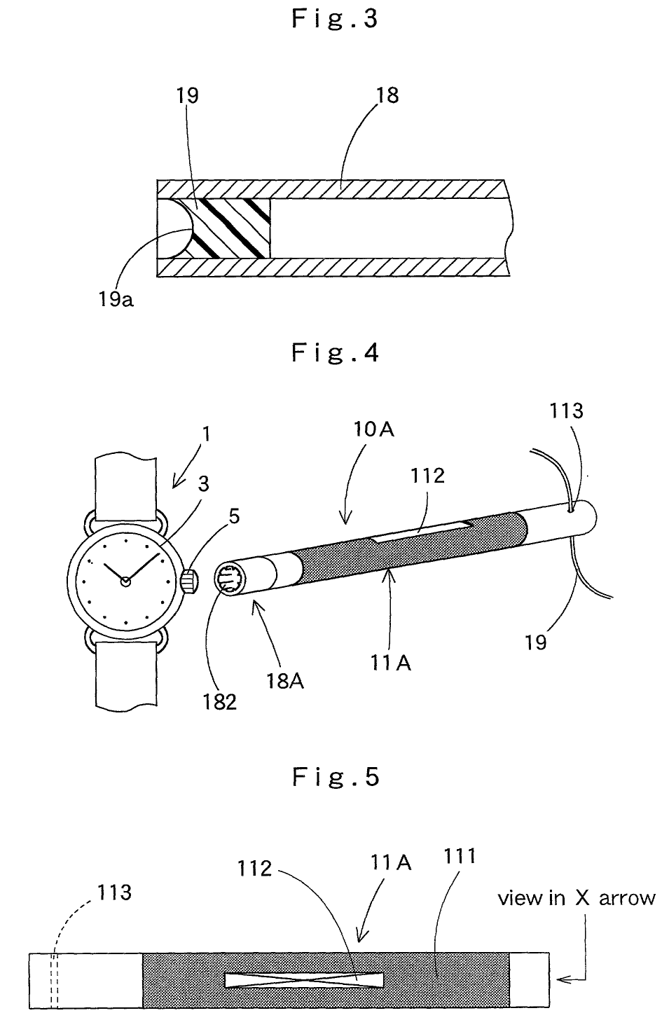

In the crown engaging part 18, in the embodiment, a thin pipe made of aluminum, iron or stainless steel having relatively high strength is used. One end is formed to be fitted to the attachment 15 in the state which is capable of being put on and taken off, and at one end, as shown in FIG. 3, a crown female die 19a made of a thermoplastic resin material 19 is formed in recess state at the top end of the pipe. The crown female die 19a is formed in that the thermoplastic resin material 19 is filled, in the top end part of the pipe and then is made the high temperature state and the crown 5 of the prescribed wristwatch 1 is inserted along the axial center direction from the head part side. After the female die 19a of the crown 5 is formed at the high temperature state, the thermoplastic resin is made the low temperature and hardened thereby the female die 19a is made to be used. When dies of various sorts of size corresponding to the crown 5 of various sorts of the wristwatch 1 are previously formed and stored, the crown 5 can be tightened corresponding to various sorts of the wristwatch 1.

In addition, the crown engaging part 18 and the attachment 15 are integrated and various sorts of size may be formed so that one end of the crown engaging part 18 can be engaged with the recess 17 of the attachment 15. Further the attachment is not used and the crown engaging part 18 may be formed to be installed directly to the operation handle body 11.

The crown tightening tool 10 according to the first embodiment as above described, is used in the operation for tightening the crown 5 firmly when man dives in a water or enters a bath in the state that a water-proof watch 1 is put on an arm, and in the winding operation in an automatic winding wristwatch and further in the operation in adjustment of hour, adjustment of date or other function. When the crown tightening tool 10 is used, the female die 19a of the crown engaging part 18 is arranged in opposition to the crown 5 and is inserted along the axial center of the crown 5 from the head side. Since the female die 19a is fitted to size of the crown 5, the crown engaging part 18 is inserted and rotates the operation handle body 11 thereby the crown 5 projected from the watch body 3 can be tightened firmly.

Also when the operation handle body 11 constitutes a ratchet mechanism rotatable in one direction and prescribed torque can be limited, the crown 5 can be tightened in prescribed torque and is not damaged due to excessive tightening.

In addition, when a skidproof tape is wound on the crown engaging part 18 partly, the crown can be tightened in sole body without installed to the operation handle body 11.

In addition, the crown tightening tool in the first embodiment having an engaging part capable of being engaged with the crown 5 and an operation handle body formed to be capable of being put on and taken off through the attachment, is not limited to that shown in FIG. 2, but as shown in FIGS. 4 to 9, a crown tightening tool 10A provided with a handle part 11A formed in long round pin shape (or long square pin shape) and arranged to be capable of being put on and taken off an engaging part 18A, and with an engaging part 18A having a recess capable of being engaged with the crown 5 may be used.

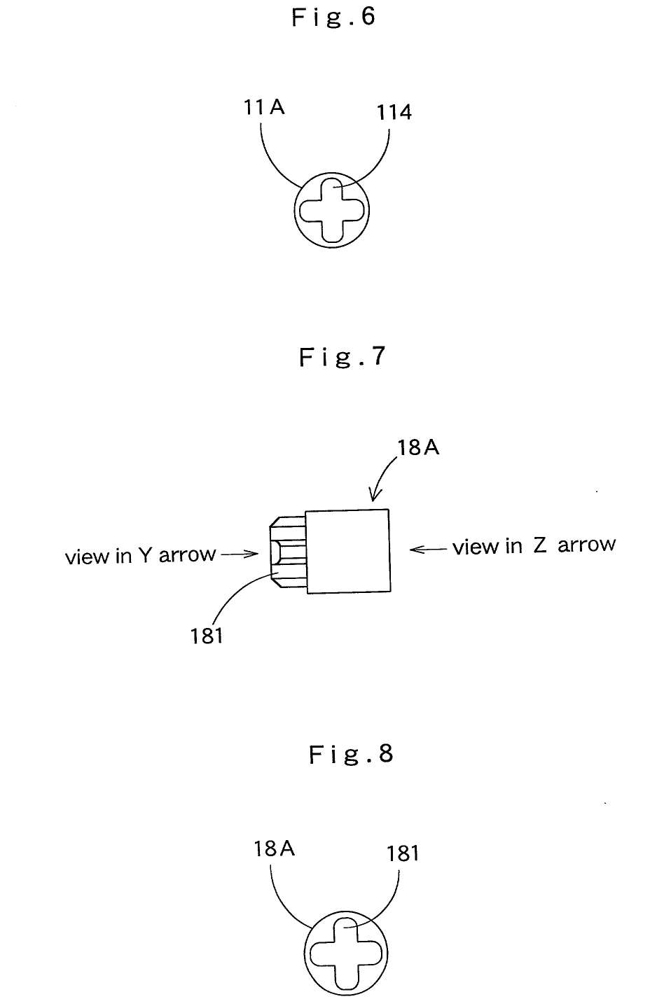

The handle part 11A as shown in FIGS. 5 to 6, is formed in long round pin shape, and at the center part in prescribed width dimension, a knurling treatment part 111 as skid prevention is applied for easy operation by hands, and a slender plane part 112 is formed at the center of the knurling treatment part 111 partly. Further at one end side of the handle part 11, for example, a small hole 113 is formed to penetrate in the diameter direction and a neck string is to be inserted in the small hole 113.

Also on the end surface at the opposite side of the small hole 113, as shown in FIG. 6, an engaging recess 114 of cross shape is formed and can be engaged with the engaging part 18A. In addition, in the slender plane part 112, a name of a usable maker is written, when a wristwatch of an exclusive maker is used, a crown tightening tool 10A with an engaging part 18A for the maker installed to the handle part 11A may be possessed.

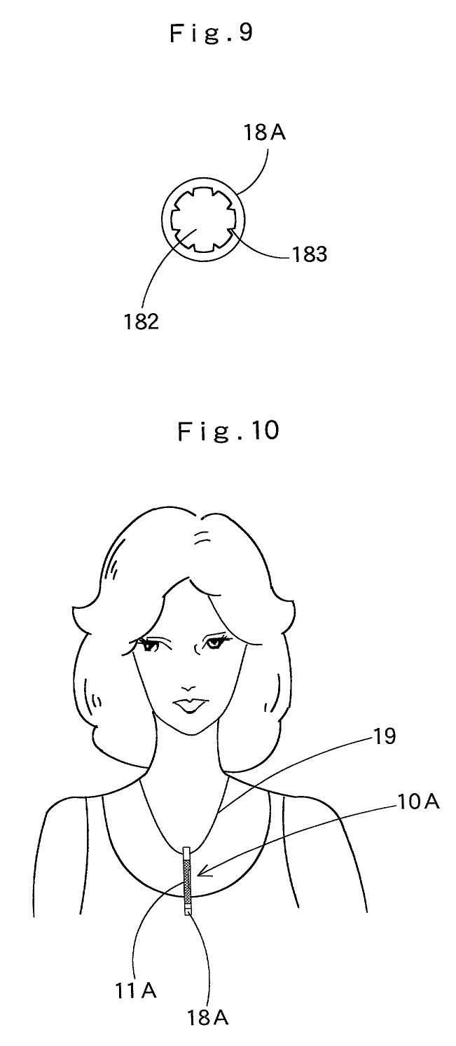

The engaging part 18A is used as an attachment formed against each exclusive maker, and as shown in FIGS. 7 to 9, it is formed by a material softer than the crown 5, for example, resin, duracon or the like, and has outer diameter nearly equal to that of the handle part 11A. One end of the engaging part 18A has an engaging projection 181 which is formed in cross shape capable of being fitted to the engaging recess 114 of the handle part 11A (refer to FIG. 8), and other end of the engaging part 18A has an engaging recess 182 which can be engaged with the crown 5 (refer to FIG. 9). The engaging recess 182 may be provided with an inner groove in the same shape as that of a number of projection grooves formed on the outer circumferential surface of the crown 5, and as shown in FIG. 9, an engaging projection 183 may be formed within the engaging recess 182. The engaging projection is divided in six or eight and can be engaged with a number of groove parts of the crown.

In the crown tightening tool 10A, the engaging projection 181 of the engaging part 18A is engaged with the engaging recess 114 of the handle part 11A and integrated, and the engaging recess 182 of the engaging part 18A is fitted to the outer circumference of the crown 5 thus the crown 5 is rotated, and adjustment of hand, adjustment of date and adjustment of other function can be performed.

When the crown 5 is not tightened by the crown tightening tool, as shown in FIG. 10, if a neck string 19 is inserted in the small hole 113 formed on the handle part 11A and is hung on the neck, the crown tightening tool can be used as a pendant. Particularly when the handle part 11A or the engaging part 18A is formed by precious metals such as K18-carat gold, platina, K 18-carat white gold or the like, the pendant becomes further valuable as an accessory. Further the fitting recess 182 can be used as a whistle when the fitting recess 182 is installed to the handle part 11A and breath is blown from one end. In case of dangerous state, the whistle can be blown so as to prevent the dangerous state.

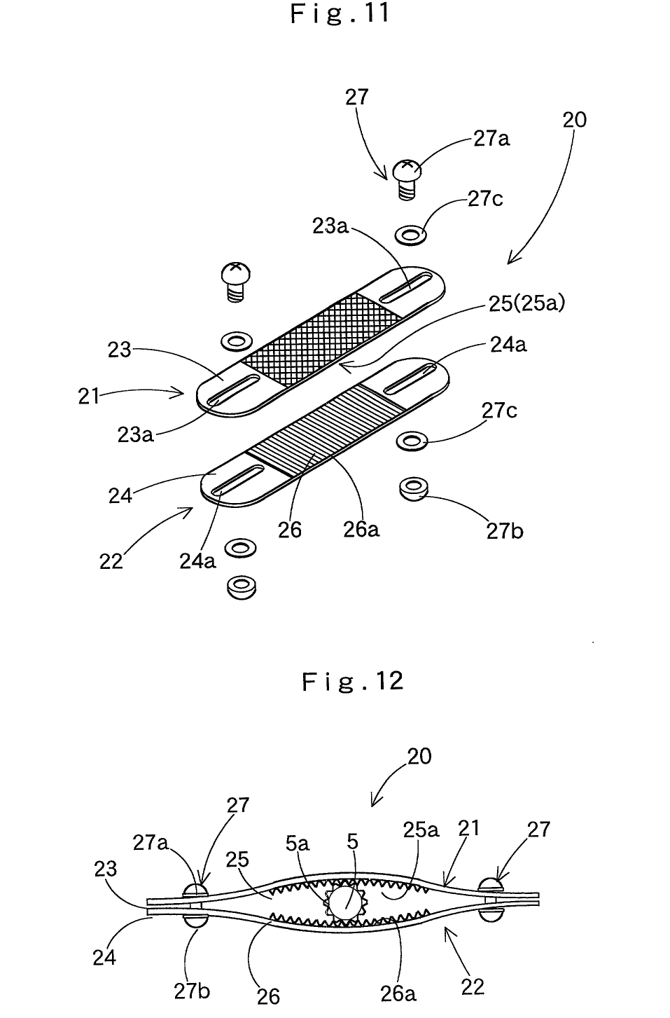

A crown tightening tool 20 in a second embodiment, as shown in FIG. 11, comprises a pair of engaging plates 21, 22 arranged with respect to a crown 5 and capable of holding the crown 5. The pair of engaging plates 21, 22 are constituted in that on elastic plates 23, 24 being thin and made of iron or stainless steel, rubber plates 25, 26 as a crown engaging part having a number of locking grooves 25a, 26a engaging with a longitudinal groove 5a of the crown 5 are applied toward the opposite sides with respect to the center part, and on both ends, oval holes 23a, 24a are formed along the longitudinal direction, and a screw set 27 coupling the pair of elastic plates 23, 24 is installed to each of the oval holes 23a, 24a.

For the slidable installation at both sides of the pair of engaging plates 21, 22, the screw set 27 is constituted in assembling of a machine screw 27a penetrating the oval holes 23a, 24a, a nut 27b capable of being attached to the machine screw 27a and a washer 27c. When dimension between a head part of the machine screw 27a and the nut 27b is made larger than thickness of the pair of elastic plates 23, 24 can be moved with each other, the slidable assembling is performed.

Consequently the pair of engaging plates 21, 22 are mounted to be slidable with each other by the oval holes 23a, 24a. The elastic plates 23, 24 have the energizing force so that when the elastic plates 23, 24 are bent with respect to the plane, they are apt to restore to the plane. Therefore if the length of the machine screw 27a of the screw set 27 is smaller than the width of the crown 5, as shown in FIG. 12, the pair of elastic plates 25, 26 are formed so that the portion engaging with the crown 5 is projected to swelling in comparison with the portion supported by the screw sets 27 at both sides. Since the elastic plates 23, 24 have the energizing force in the plane direction, the elastic plates 23, 24 are pushed in the direction holding the crown 5. Installation is performed in engaging the longitudinal groove 5a of the crown 5 by the locking grooves 25a, 26a of the rubber plates 25, 26.

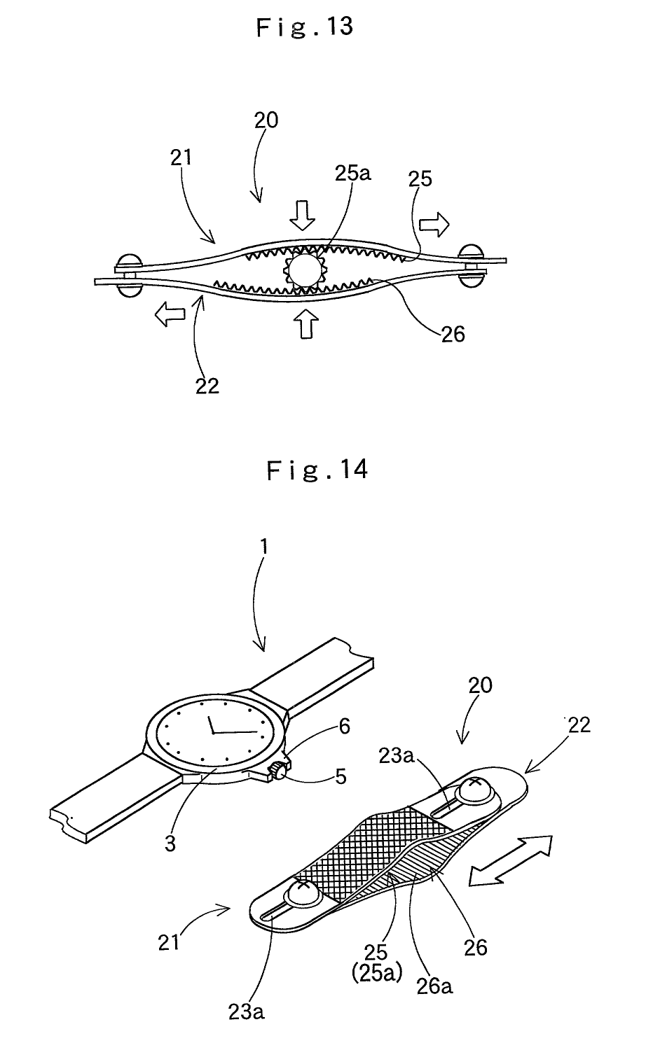

Consequently as shown in FIG. 13, when locking grooves 25a, 26a of a pair of rubber plates 25, 26 are engaged with the longitudinal groove 5a of the crown 5 and a pair of engaging plates 21, 22 are mutually slided along the oval holes 23a, 24a, the crown 5 is screwed toward the direction to be tightened. This is repeated thereby the crown 5 can be tightened by prescribed force. In this case, the crown 5 is attached with the rubber plates 25, 26, thereby since the frictional resistance is made large and the skid is not easily produced, the crown 5 is easily rotated.

Since the crown tightening tool 20 in this embodiment is installed in parallel to the opposite surfaces of the crown 5, as shown in FIG. 14, it is suitable to tighten a wristwatch (water-proof watch) 1A in which a crown guard 6 is formed. Since a gap between the wall of the crown guard 6 and the crown 5 is made quite small, for example, the crown tightening tool 10 having the wall in whole circumference as in the first embodiment can not be inserted between the wall of the crown guard 6 and the crown 5. Consequently even if the wall of the crown guard 6 is arranged in one direction, when the direction orthogonal to this is released, the engaging plates 21, 22 can be arranged in the released position thereby the crown can be tightened.

In addition, in the crown tightening tool 20 in this embodiment, if skid preventing working is applied to the opposite surface to the rubber plates 25, 26 in the elastic plates 23, 24 are slided by hands, the crown tightening tool 20 can be slided sufficiently. If the locking grooves 25a, 26a are formed on the surface opposite to the crown 5, the elastic plates 23, 24 and the rubber plates 25, 26 may be formed integrally by the elastic plates or may be formed integrally by the rubber plates.

Further since the crown tightening tool 20 in this embodiment can be put on a human body and used as an accessory, it is suitably possessed by woman.

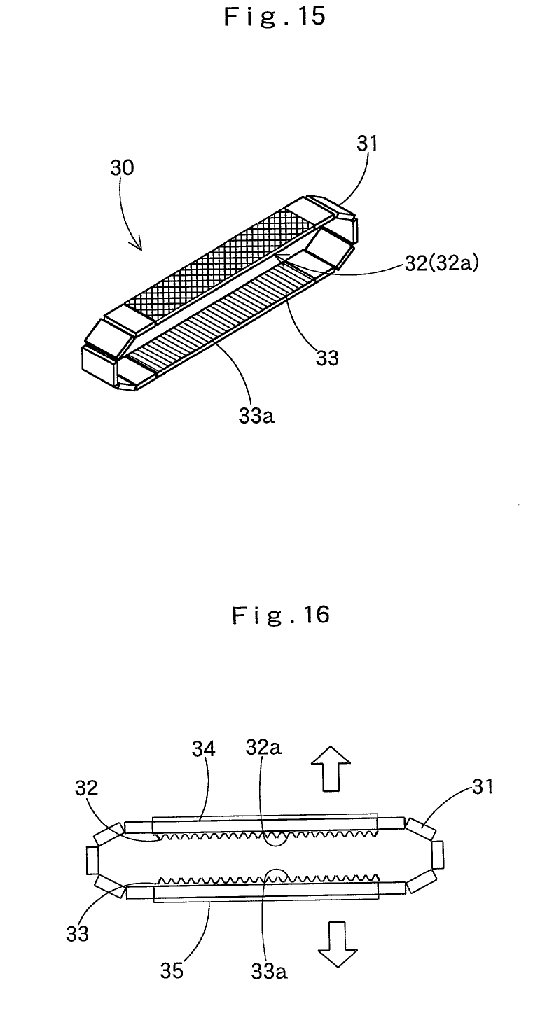

In a crown tightening tool 30 in a third embodiment, as shown in FIGS. 15 to 16, to a band member 31 having two opposite linear surfaces and formed as a ring member in endless state, a pair of rubber plates 32, 33 as a crown engaging part are installed along the opposite surfaces in the linear direction. In the rubber plates 32, 33, a number of locking grooves 32a, 33a are formed and engaged with the longitudinal groove 5a formed in the crown 5. The band member 31 is preferably formed in that a number of single rectangular plates are connected in elastic state and formed in expandable state along the longitudinal direction, as known in a band of a conventional watch. In the band member 31, on the surface side opposite to the surface on which the rubber plates 32, 33 are installed, thin plates 34, 35 with the skid preventing working applied are installed respectively.

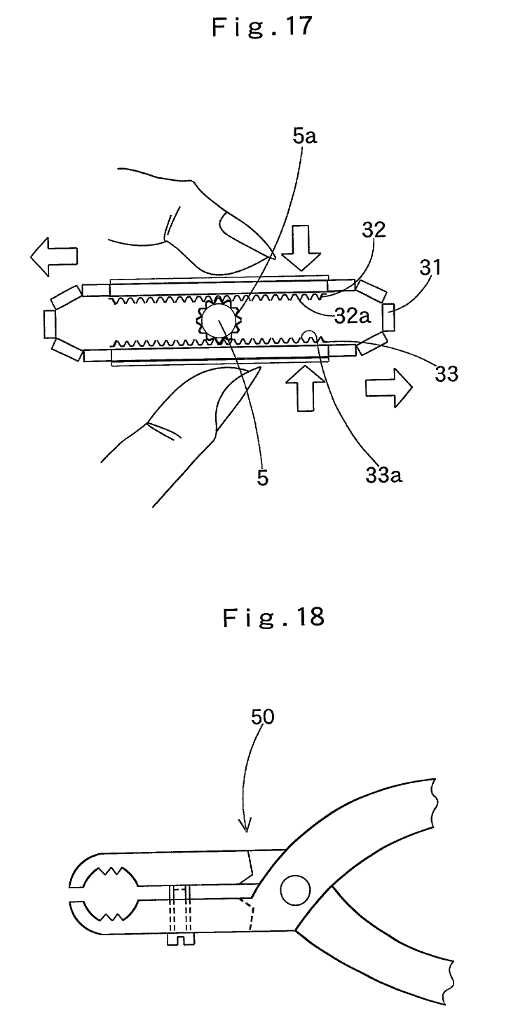

The crown tightening tool 30 is installed on both opposite surfaces of the crown 5 of the wristwatch 1, in similar manner to the crown tightening tool 20 in the second embodiment, and the locking grooves 32a, 33a are arranged to the longitudinal groove 5a of the crown 5 at the opposite position. As shown in FIG. 17, if a finger is attached to the thin plates 34, 35 with the skid preventing working applied, the locking grooves 32a, 33a and the longitudinal groove 5a are engaged with each other and after rotation in one direction, the crown 5 is tightened.

The crown tightening tool 30 in this embodiment can be suitably used in a wristwatch where the crown guard 6 is formed, in similar manner to the crown tightening tool 20 in the second embodiment. Further since the crown tightening tool 30 is formed in the ring shape, when it is put on an arm improving the design property, it can be used as a bracelet and is suitably possessed by woman.

In place of the band member of ring shape in endless state, the locking grooves 32a, 33a as a crown engaging part may be arranged at the rear surface side of the linear part, and an iron plate with the skid preventing working applied, or a rubber plate or a plate formed by other material may be arranged at the front surface side, and semicircular ring parts on both sides may be coupled by the band member 31.

As above described, the crown tightening tool is installed to the crown 5 projected from the watch body 3 and engaged, thereby the crown 5 can be tightened securely although it can not be sufficiently tightened in operation by hands. Thereby in the case of the water-proof wristwatch 1, since the crown 5 can be tightened to the prescribed position, the waterproofing effect can be strengthened.

Also when the crown engaging part 18 of the crown tightening tool 10 is formed to be arranged to be capable of being put on and taken off the operation handle body 1, the crown engaging part 18 can be engaged along the axial center of the crown 5 thus the tightening work can be performed quite easily.

When the thermoplastic resin 19 is filled in the crown engaging part 18 of the crown tightening tool 18 of the crown tightening tool 10, in the state that the thermoplastic resin 19 is filled in the crown engaging tool 10, in the state that the thermoplastic resin 19 is made the high temperature, if the thermoplastic resin 19 is pushed to the crown 5, the crown female die 19a can be molded in the thermoplastic resin 19 and the crown tightening tool 10 fitted to various sorts of watches respectively can be provided.

Further if the handle part 11A is formed in long round pin shape and a small hole 113 is formed in one end part, for example, when a neck string is inserted in the small hole 113, the crown tightening tool as an accessory having the engaging part 18A engaged with the handle part 11A can be put on a human body.

The crown tightening tool 20 has a pair of engaging plates 21, 22 arranged in parallel with respect to the crown 5 and formed slidable mutually, since the crown 5 can be tightened by only engaged with the two opposite surfaces of the crown 5 and slided, the crown tightening tool 20 can be used corresponding to various sorts of watches being different in shape of the crown 5. Moreover, a pair of engaging plates 21, 22 formed in plate shape are attached to a human body thereby the function as the tool is not used and it can be used as an accessory.

If the locking grooves 25a, 26a to be engaged with the longitudinal groove 5a of the crown 5 are formed on the rubber plates 25, 26 of the crown tightening tool 20, when a pair of engaging plates 21, 22 are slided, the crown 5 can be tightened sufficiently, and in the case of the water-proof watch 1, the water proofing effect can be strengthened.

Also if a pair of elastic plates 23, 24 are formed by an elastic member energizing in the direction getting close to each other, when the crown tightening tool 20 is engaged with the crown 5, since the crown can be constituted to be always held, the tightening operation of the crown 5 can be performed easily.

Also if the crown tightening tool 30 is formed in endless state including the rubber plates 32, 33 engaged with the crown 5, after engaging with the crown 5, the band member 31 is moved to be rotated in one direction, thereby the tightening operation of the crown 5 can be performed easily. Moreover if the crown tightening tool 30 formed in endless state as a bracelet is put on an arm, it can be used as an accessory.

If the locking grooves 32a, 33a to be engaged with the longitudinal groove 5a of the crown 5 are formed on the rubber plates 32, 33 of the crown tightening tool 30, the crown 5 can be tightened sufficiently, and in the case of the water-proof watch 1, the waterproofing effect can be strengthened.

1. A crown tightening tool to tighten a crown of a wristwatch, wherein:
(a) the crown tightening tool is provided with an engaging part capable of being engaged with the crown in the projected state from a watch body, and with an operation handle part to be arranged to be capable of being put on and taken off the engaging part, and is formed linearly;
(b) the engaging part is provided with a fitting recess to be engaged with all or a part of a groove part formed on an outer circumferential surface of the crown, and with a handle engaging part capable of being engaged with the operation handle part; and
(c) the operation handle part is rotated along the axial center, thereby the crown can be rotated.

2. A crown tightening tool to tighten a crown of a wristwatch, wherein:
(a) the crown tightening tool is provided with an engaging part capable of being engaged with the crown in the projected state from a watch body, and with an operation handle part to be arranged to be capable of being put on and taken off the engaging part, and is formed linearly;
(b) the engaging part has a recess molded on the outer circumferential surface of the crown; and
(c) thermoplastic resin is filled in the recess and is fitted to the crown at high temperature state thereby a female die of the crown is formed in the recess.

3. A crown tightening tool as set forth in claim 1, wherein the operation handle part is formed in long pin shape and a small hole is formed in one end part.

4. A crown tightening tool as set forth in claim 2, wherein the operation handle part is formed in long pin shape and a small hole is formed in one end part.

5. A crown tightening tool to tighten a crown of a wristwatch, wherein:
(a) the crown tightening tool has an engaging part capable of being engaged with the crown in the projected state from the watch body and is constituted to be capable of being put on and taken off the crown;
(b) the engaging part has a pair of plates arranged in parallel with respect to the crown, and the pair of plates are installed slidable mutually; and
(c) the pair of plates hold the crown and then are moved in reverse directions thereby the crown can be rotated.

6. A crown tightening tool as set forth in claim 5, wherein locking grooves are formed on the surfaces opposite to the crown in the pair of plates, and can be engaged with the groove part formed on the outer circumferential part of the crown.

7. A crown tightening tool as set forth in claim 6, wherein the pair of plates are formed having elastic material with the engaging force acting in the direction mutually coming close.

8. A crown tightening tool to tighten a crown of a wristwatch, wherein:
(a) the crown tightening tool has an engaging part capable of being engaged with the crown in the projected state from the watch body and is constituted to be capable of being put on and taken off the crown;
(b) the engaging part has a pair of plates arranged in parallel with respect to the crown and the pair of plates are formed in endless state with both ends connected; and
(c) the pair of plates hold the crown and then are moved in one direction thereby the crown can be rotated.

9. A crown tightening tool as set forth in claim 8, wherein locking grooves are formed in the pair of plates, and can be engaged with the groove part formed on the outer circumferential surface of the crown.
